(19) United States
(12) Patent Application Publication
(10) Pub. No.: US 2011/0020054 A1
(43) Pub. Date: Jan. 27, 2011

(54) THERMAL STRAIN RELIEF DEVICE FOR HIGH TEMPERATURE FURNACE

(75) Inventor: Keith Vaillancourt, Pelham, NH (US)

Correspondence Address: EDWARDS ANGELL PALMER & DODGE LLP, P.O. BOX 55874, BOSTON, MA, 02205, US

(73) Assignee: GT SOLAR INTERNATIONAL, INC., Merrimack, NH (US)

(21) Appl. No.: 12/844,319

(22) Filed: Jul. 27, 2010

Related U.S. Application Data
(60) Provisional application No. 61/228,852, filed on Jul. 27, 2009.

(51) Int. Cl. F16D 1/00; B23P 19/00

(52) U.S. Cl. 403/30; 29/428

(57) ABSTRACT

A system and method for connecting a plurality of components in a furnace incorporate a thermal strain relief device made of graphite or other material designed for high temperature environments in which operating temperatures of the furnace are between about 1000° C. and about 1700° C. The thermal strain relief device includes a body, a raised area provided on a first side of the body, and an elevation structure provided on a second side of the body. The thermal strain relief device is assembled with at least first and second components, and a connector for connecting the first and second components in the furnace, where the first and second components may have different coefficients of thermal expansion, and the thermal strain relief device is configured to flex in response to tightening of the connector, and in response to thermal expansion of the first and second components when operated at high temperatures.

### CROSS-REFERENCE TO RELATED APPLICATION

This application claims the benefit of copending application U.S. Provisional Application Ser. No. 61/228,852 filed on Jul. 27, 2009, the disclosure of which is expressly incorporated herein by reference in its entirety.

### FIELD OF INVENTION

The present invention relates to systems and methods for connecting components in high temperature environments including furnaces, and more particularly to a thermal strain relief device used for connecting components with different rates of thermal expansion.

### BACKGROUND OF THE INVENTION

Directional solidification systems (DSS) are used for the production of multicrystalline silicon ingots, for example, in the photovoltaic and semiconductor industries. A DSS furnace is used for crystal growth and directional solidification of a starting material such as silicon. In DSS processes, silicon feedstock can be melted and directionally solidified in the same furnace. Operating temperatures of the furnace typically are from room temperature to about 1700° C. during various stages of heating, melting of the silicon feedstock, and growth by directional solidification of a silicon ingot. In particular, because silicon melts at 1412° C., the furnace operates at temperatures between about 1415° C. and about 1550° C. during the melting stage, followed by growth or directional solidification, and subsequently a cool-down stage. In other words, sustained operating temperatures are commonly maintained above about 1000° C. in the DSS furnace. Such furnaces also can be used to grow silicon ingots for semiconductor processing. Other types of furnaces for photovoltaic or semiconductor processing, and other types of heating apparatus may have similarly high operating temperatures. Such high temperatures and/or environments are not suitable for traditional components made of steel and most other metals. In particular, when operating temperatures exceed about 600° C., thermal expansion should be considered, and failure rates may increase when operating temperatures exceed about 1000° C.

Thermal expansion is the tendency of a component to exhibit a dimensional change in response to a change in temperature. The degree of expansion divided by the change in temperature is referred to as the coefficient of thermal expansion and generally varies with temperature. Materials with anisotropic structures, such as crystals and composites, will generally have different expansion coefficients in different directions. For example, graphite expands in a direction perpendicular to its layers in a manner different from that within the layers.

In high temperature environments such as furnaces with operating temperatures above about 1000° C., if components made of different materials are assembled together, the thermal expansion coefficients of the components must be considered, so that premature failure of one or more of the components is avoided. For example, in a DSS furnace, various components such as heaters and electrodes typically are mounted together in a “hot zone” in which temperatures typically are between about 1000° C. and about 1700° C. for extended periods of time during various stages of processing. However, due to thermal expansion mismatches between studs used to connect the heaters and/or electrodes, these respective components may expand at different rates even when subjected to similar temperatures. This can cause poor mechanical integrity, electrical contact, failure, etc.

It would be desirable to provide a device for reducing the impact of thermal mismatches between various components in the “hot zone” of a DSS furnace or other furnaces. It would also be desirable to provide such a device that can be used in conjunction with assembling or connecting together one or more of these components, such that the device would be capable of limiting stresses in studs to counteract thermal mismatch.

### SUMMARY OF THE INVENTION

Systems and methods are provided for connecting a plurality of components in a furnace or other high temperature environment, according to the subject invention. Such systems and methods incorporate a thermal strain relief device arranged in conjunction with an assembly of a connector and at least first and second components in the furnace. The furnace can be any type of furnace designed for use in high temperature applications in which operating temperatures can exceed about 1000° C. In particular, the furnace can be a crystal growth furnace with typical operating temperatures of about 1000° C. to about 1700° C.

The thermal strain relief device according to the subject invention preferably is arranged intermediate at least a portion of the connector and at least one of the first and second components. Preferably the thermal strain relief device substantially maintains contact with the connector and at least one of the first and second components when assembled in the furnace. The connector and the first and second components may be made of materials having different coefficients of thermal expansion. As a result, when the thermal strain relief device is assembled with the connector and at least the first and second components in the furnace, the thermal strain relief device is configured to flex, bend, or otherwise deform elastically in response to a load, where the load can be caused, for example, by the different rates of thermal expansion of the connector and the first and second components. Further, the thermal strain relief device is configured to flex in response to initial tightening and/or re-tightening of the connector against the thermal strain relief device.

The thermal strain relief device preferably is formed with at least a body having first and second sides, a raised area provided on the first side of the body, and an elevation structure provided on the second side of the body. During assembly, the raised area preferably substantially maintains contact with the connector, for example, in order to provide a surface for tightening the connector against the thermal strain relief device, which functions essentially as a spring clip or washer. The thermal strain relief device can be formed with a hole extending therethrough for receiving the connector. The body of the thermal strain relief device is configured to flex under load conditions such as initial tightening or re-tightening of the connector, and during thermal expansion of one or more components provided in the furnace.

A system for connecting a plurality of components in a furnace, can include at least first and second components provided in the furnace; a connector for connecting the at least first and second components in the furnace, the connector and the first and second components being made of materials having different coefficients of thermal expansion; and a thermal strain relief device arranged intermediate at least a portion of the connector and at least one of the first and second components, the thermal strain relief device abutting the connector and the at least one of the first and second components, the thermal strain relief device having a body, a raised area provided on a first side of the body, the raised area contacting the connector, and an elevation structure provided on a second side of the body for contacting the at least one of the first and second components.

A thermal strain relief device configured to be assembled with a connector and at least first and second components in a furnace, can include a body; a raised area provided on a first side of the body, the raised area contacting the connector that connects at least first and second components, wherein the connector and the first and second components have different coefficients of thermal expansion; and an elevation structure provided on a second side of the body for contacting the at least one of the first and second components, the thermal strain relief device being arranged intermediate to at least a portion of the connector and at least one of the first and second components.

A method for connecting a plurality of components in a furnace, can include at least the following steps: providing at least first and second components in the furnace; providing a thermal strain relief device having a body, a raised area provided on a first side of the body, and an elevation structure provided on a second side of the body; connecting the at least first and second components in the furnace using a connector, where the connector and the first and second components are made of materials having different coefficients of thermal expansion; tightening the connector against the raised area of the thermal strain relief device, such that the raised area contacts the connector, and the elevation structure contacts at least one of the first and second components; and subjecting the thermal strain relief device, the connector, and the at least first and second components to a high temperature environment, the connector being configured to flex in response to different thermal expansion rates of the connector and the first and second components. Further, the high temperature environment includes operating temperatures of greater than about 1000° C., and more preferably about 1000° C. and about 1700° C. The thermal strain relief device is configured to flex in response to the tightening of the connector against the raised area of the thermal strain relief device, where the thermal strain relief device flexes so as to counteract thermal expansion of at least one of the connector, the first component, and the second component.

Other aspects and embodiments of the invention are discussed below.

### BRIEF DESCRIPTION OF THE DRAWINGS

For a fuller understanding of the nature and desired objects of the present invention, reference is made to the following detailed description taken in conjunction with the accompanying drawing figures wherein like reference character denote corresponding parts throughout the several views and wherein:

FIG. 1 is a perspective view of a connection area of a furnace incorporating a strain reducing device according to the subject invention;

FIG. 2A is a front view of the connection area depicted in FIG. 1;

FIG. 2B is a cross-sectional side view across a section 2B-2B depicted in FIG. 2A;

FIG. 2C is a side view of the connection area depicted in FIG. 1;

FIG. 3A is an isolated perspective view of a strain reducing device according to the subject invention;

FIG. 3B is a top plan view of the strain reducing device of FIG. 3A;

FIG. 3C is a side view of the strain reducing device of FIG. 3B;

FIG. 3D is a cross-sectional side view across a section 3D-3D depicted in FIG. 3C;

FIG. 4 is an enlarged perspective view of the strain reducing device of FIG. 3A;

FIG. 5 is a diagram indicating typical bending stresses that may impact the strain reducing device of the subject invention;

FIG. 6 is a diagram indicating deformation of the strain reducing device under typical initial tightening loads; and

FIG. 7 is a perspective view of multiple strain reducing devices provided in a furnace according to the subject invention.

### DEFINITIONS

The instant invention is most clearly understood with reference to the following definitions:

As used in the specification and claims, the singular form “a”, “an” and “the” include plural references unless the context clearly dictates otherwise.

A “furnace” or “crystal growth apparatus” as described herein refer to any device or apparatus used to promote crystal growth and/or directional solidification, including but not limited to crystal growth furnaces and directional solidification (DSS) furnaces, where such furnaces may be particularly useful for growing silicon ingots for photovoltaic (PV) and/or semiconductor applications. The term “furnace” also refers to any device used for heating, including those suitable for high temperature applications in which operating temperatures exceed about 1000° C.

### DETAILED DESCRIPTION OF THE INVENTION

Systems and methods are provided for connecting a plurality of components in a furnace or other high temperature environment, according to the subject invention. Such systems and methods incorporate a thermal strain relief device arranged in conjunction with an assembly of a connector and at least first and second components in the furnace. The furnace can be any type of furnace designed for use with high temperature applications in which operating temperatures can exceed about 1000° C. For example, the furnace may be a crystal growth apparatus used for photovoltaic or semiconductor manufacturing processes, and can be used in conjunction with a directional solidification system (DSS). A DSS furnace is used to grow silicon ingots, and typically operates at high temperatures of up to about 1700° C. Alternatively, the furnace may be capable of operating at any temperature, and in particular, operating temperatures greater than about 600° C. in which differing rates of thermal expansion of disparate components may affect performance of the components.

The thermal strain relief device according to the subject invention preferably is arranged intermediate at least a portion of the connector and at least one of the first and second components. Preferably the thermal strain relief device substantially maintains contact with the connector and at least one of the first and second components when assembled in the furnace. The connector and the first and second components may be made of materials having different coefficients of thermal expansion. As a result, when the thermal strain relief device is assembled with the connector and at least the first and second components in the furnace, the thermal strain relief device is configured to flex, bend, or otherwise deform elastically in response to a load, where the load can be caused, for example, by the different rates of thermal expansion of the connector and the first and second components. Further, the thermal strain relief device is configured to flex in response to initial tightening or re-tightening of the connector against the thermal strain relief device.

The thermal strain relief device preferably is formed with at least a body having first and second sides, a raised area provided on the first side of the body, and an elevation structure provided on the second side of the body. During assembly, the raised area preferably substantially maintains contact with the connector, for example, in order to provide a surface for tightening the connector against the thermal strain relief device, which functions essentially as a spring clip or washer. The thermal strain relief device can be formed with a hole extending therethrough for receiving the connector. The body of the thermal strain relief device is configured to flex under load conditions such as initial tightening or re-tightening of the connector, and during thermal expansion of one or more components provided in the furnace.

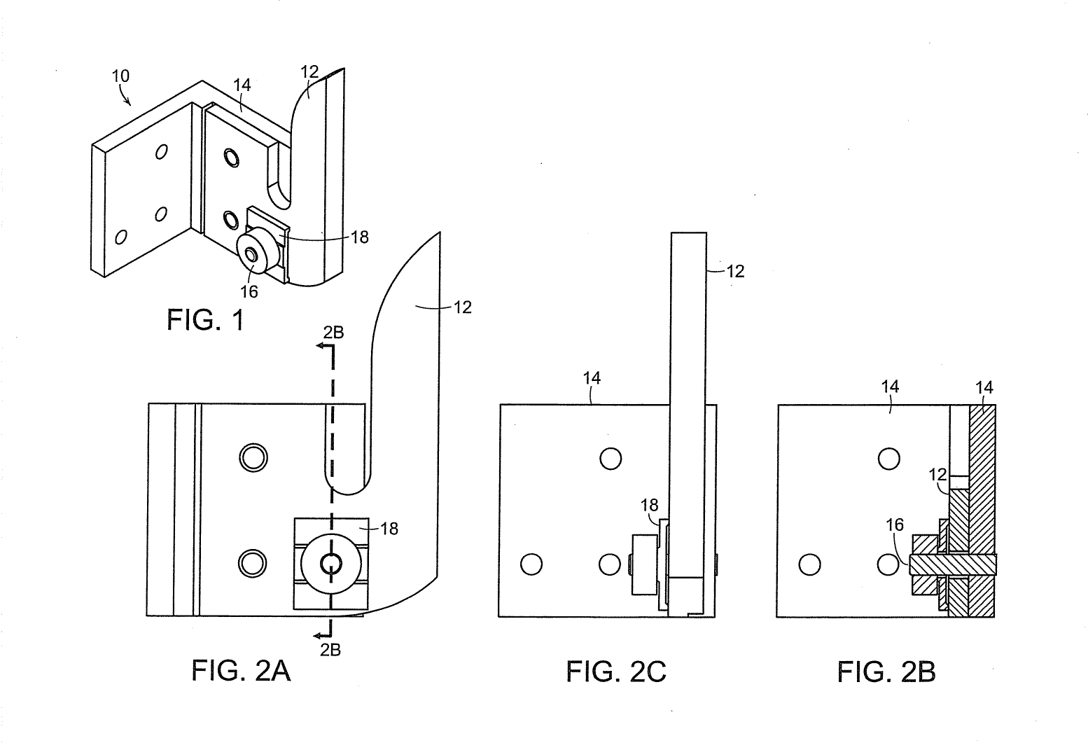

A section of a furnace is depicted in FIGS. 1 to 2C, in particular, a connection area 10 for connecting one or more components, which can include at least a first component 12 and a second component 14. The furnace can be a crystal growth furnace with typical operating temperatures of about 1000° C. to about 1700° C., where the first component 12 can be a heater, and the second component 14 can be an electrode. As shown in FIG. 1, for example, the second component 14 is a corner section of an electrode. A connector or stud 16 is provided to assemble at least the first and second components 12, 14. The connector 16 can be any type of conventional fastening device, including but not limited to threaded fasteners, studs, and the like.

According to the subject invention, a thermal strain relief device 18 is arranged between the connector 16 and at least one of the first and second components 12, 14. In an assembled condition, as shown in FIGS. 1 to 2C, the thermal strain relief device 18 is configured to substantially maintain contact with the connector 16 on one side of the thermal strain relief device 18, where an opposite side of the thermal strain relief device 18 preferably substantially maintains contact with at least one of the first and second components 12, 14. In the embodiment depicted in FIGS. 1 to 2C, the opposite side of the thermal strain relief device 18 substantially maintains contact with at least the first component 12 (for example, a heater).

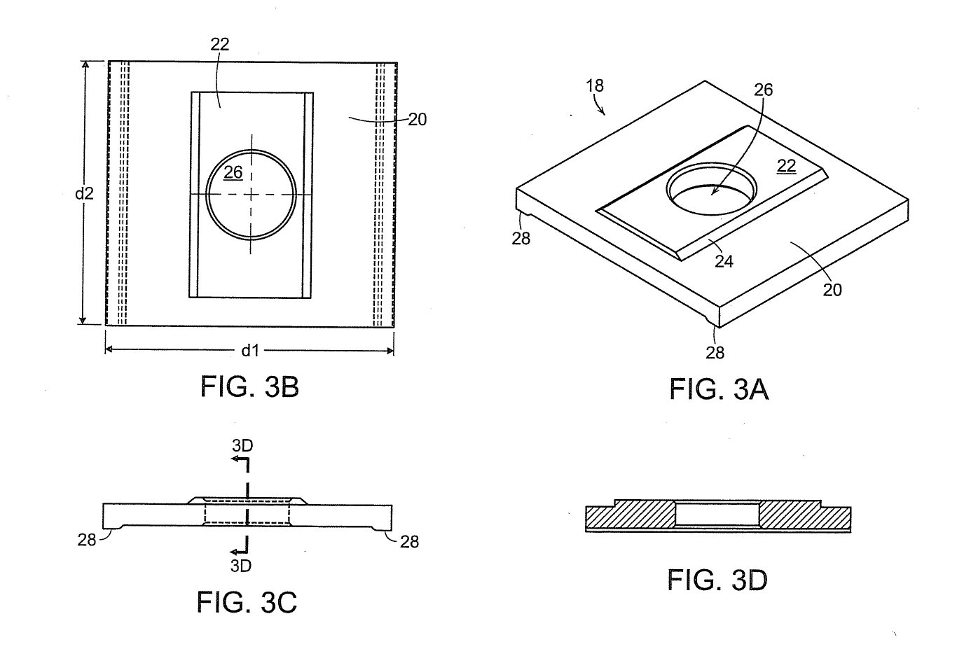

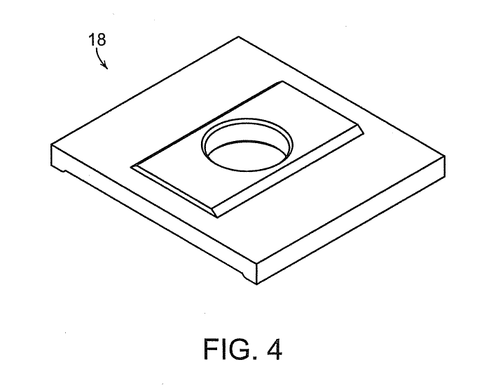

Details of the thermal strain relief device 18 are depicted in FIGS. 3A-3D. As shown in FIG. 3A, the thermal strain relief device 18 includes at least a body 20, a raised area 22 formed on a first side (the “one side” referenced above) of the body 20, and an elevation structure 28 arranged on a second side (the “opposite side” referenced above) of the body 20. As shown, the elevation structure 28 is formed with a plurality of legs, but in accordance with the subject invention, may constitute a single leg that extends substantially around the outside of the body 20 or along any portion of the body 20, and in particular, may be any structure that elevates the body above a plane defined by a surface of the body 20. For example, either a continuous or a discontinuous elevation structure can be formed on the second side of the body 20. The elevation structure 28 as shown is integral with the thermal strain relief device 18, but in other embodiments, may constitute a separate structure arranged to be connected with the body 20. Although the elevation structure 28 is depicted with two legs formed on two sides of the body 20, the elevation structure 28 may be provided along any portion or the entire perimeter of the body. Preferably a hole 26 is formed through the body 20 and the raised area 22 for receiving the connector 16, as depicted in FIGS. 1 to 2C, for example. Optionally, the hole 26 can be threaded or bonded, so as to allow a fixed connection between the thermal strain relief device 18 and the connector 16.

As described herein, the raised area 22 of the thermal strain relief device 18 preferably substantially maintains contact with the connector 16 when assembled thereto, and the raised area 22 thus provides a surface for receiving and engaging the connector 16. During assembly, the connector 16 can be tightened against the raised area 22, which preferably is elevated a predetermined distance above the body 20 so as to provide a dedicated surface to receive the connector 16. The raised area 22 optionally may include tapered edges 24, as shown, which can provide a smooth transition to the body 20. The tapered edges 24 can be formed along opposite sides of the raised area 22 and/or along the shorter ends of the raised area 22. Alternatively, the thermal strain relief device 18 can be formed without any tapered edges. Preferably the raised area 22 has a surface area and a length that is shorter than the surface area and length, respectively, of the body 20. Because of the lower surface area of the raised area 22, the connector 16 can be tightened against the raised area 22, such that remaining portions of the thermal strain relief device 18 are flexible, thus providing a spring-like action. In particular, during assembly, the thermal strain relief device 18 is capable of flexing in response to tightening of the connector 16 against the raised area 22. The raised area 22 may be provided integrally with the body 20, or alternatively, as a separate part connectable to the body 20.

The elevation structure 28 provided on the second side of the body 20 includes one or more legs that extend substantially the entire length of the thermal strain relief device 18. As shown in FIGS. 3B-3C, the elevation structure 28 extends over a distance d2 on the second side of the body 20. Alternatively, the elevation structure 28 can extend in the direction shown, but less than the distance d2. As a further alternative, the elevation structure 28 can extend over a distance d1 as shown. In an assembled condition, the elevation structure 28 substantially maintains contact with at least one of the first and second components 12, 14. In certain embodiments, the elevation structure 28 may be formed as a separate part, as distinguished from the integral elevation structure 28 depicted in FIGS. 3B-3C.

As shown in FIG. 4, the thermal strain relief device 18 can be made of a suitable carbon-based material, such as graphite, which is capable of withstanding operating conditions that regularly exceed about 1000° C. in a furnace. For example, in certain embodiments, the thermal strain relief device 18 is configured for use in a DSS furnace for growing silicon ingots at operating temperatures of up to about 1700° C. The thermal strain relief device 18 should be made of a suitable material to withstand high operating temperatures up to about 1700° C., where the thermal strain relief device 18 is configured to flex in response to thermal expansion of the connector 16 and the first and second components 12, 14. Preferably the thermal strain relief device 18 is made of any carbon-based material with a tensile strength of at least about 25 MPa, more preferably at least about 45 MPa. The minimum tensile strength of about 25 MPa is selected so as to prevent failure of the thermal strain relief device 18 due to tightening or thermal expansion in operating temperatures that exceed about 1000° C. Suitable materials having a tensile strength of between about 25 MPa and about 400 MPa are available, although the selected material may have a tensile strength greater than about 400 MPa.

The thermal strain relief device 18 preferably is made of a suitable material which can withstand high operating temperatures of up to about 1700° C. in a furnace. For example, the thermal strain relief device 18 can be made of a carbon fiber-reinforced carbon (i.e., a carbon-carbon composite) or graphite, where the selected material preferably has a low coefficient of thermal expansion, and thus negligible thermal stresses. Preferably the material should have a tensile strength of at least about 25 MPa, more preferably at least about 45 MPa. For example, one suitable material is SIGRABOND Standard 1701G, which is available from SGL Group of Saint Marys, Pa. Other suitable carbon-carbon composite materials include FC500, as sold by Across Corporation of Japan; CCM-190C, as sold by Nippon Carbon Co., Ltd. of Japan; and SIGRABOND 1001G as sold by SGL Group of Saint Marys, Pa.

Due to thermal mismatch between one or more of the connector 16 and the first and second components 12, 14, these respective components will tend to thermally expand at different rates when subjected to high temperatures of greater than about 1000° C., assuming these respective components are made of different materials having different coefficients of thermal expansion. For example, if the connector 16 expands at a faster rate than at least one of the first and second components 12, 14, a force may be applied to the raised area 22 of the thermal strain relief device 18 during operation; in response, the body 20 will tend to flex, thus counteracting the effect of thermal expansion of the connector 16. As a result, the strain experienced by the connector 16 will be reduced, as compared to an assembly that does not include the thermal strain relief device 18. In particular, the thermal strain relief device 18 of the subject invention is capable of absorbing mismatches between the coefficients of thermal expansion of the various components, and the effect of thermal swings. The material and geometry of the thermal strain relief device 18 are important to creating suitable stress levels, thus reducing strain on the respective components.

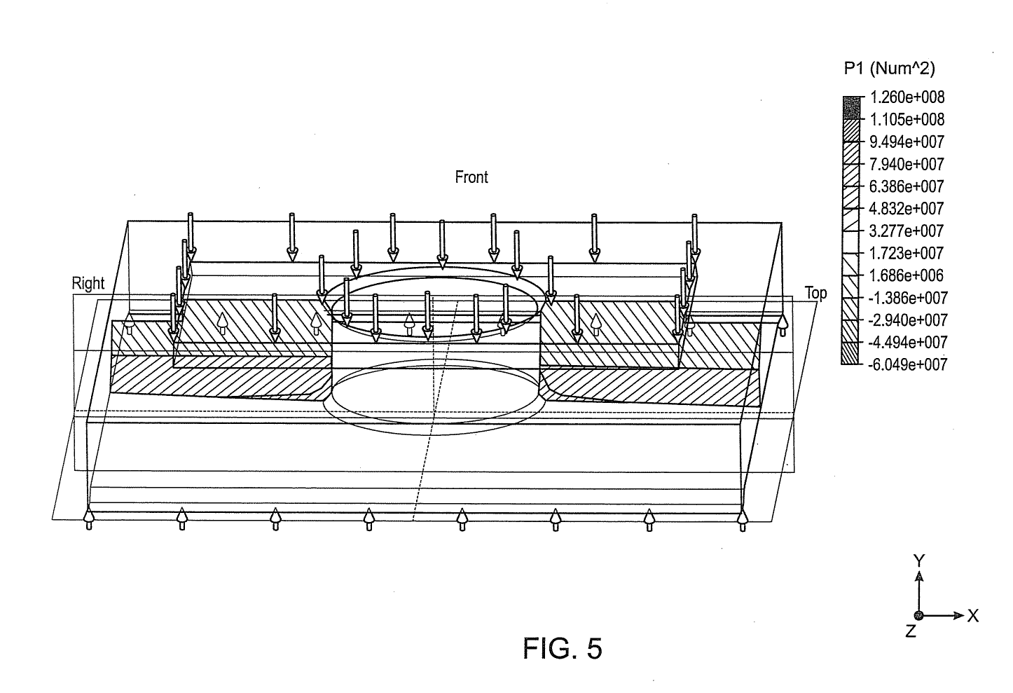

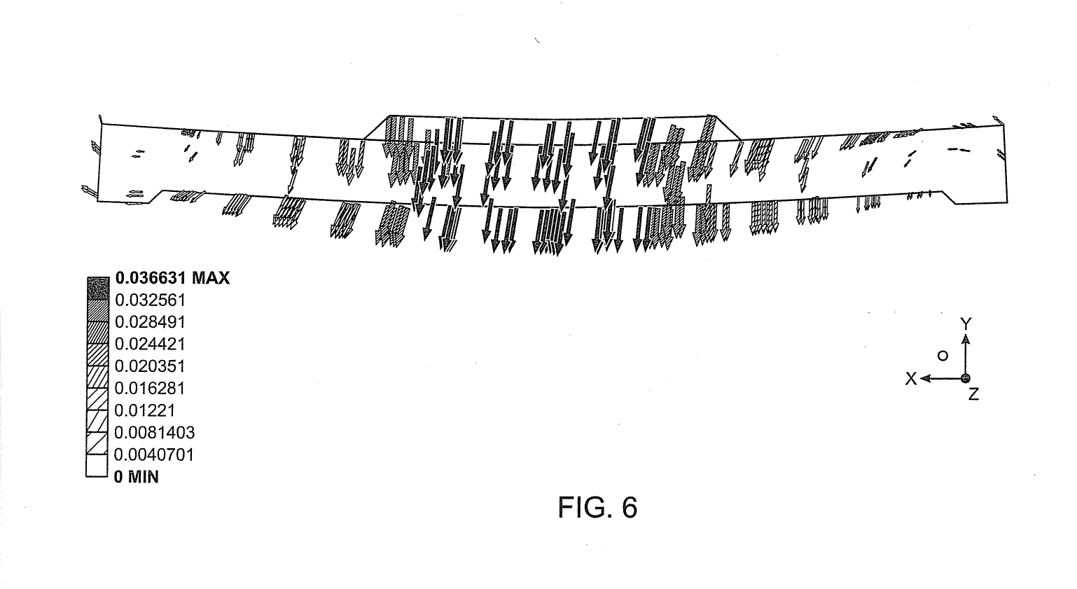

Referring to FIG. 5, contact stresses incident on the thermal strain relief device 18 are schematically depicted, where it is shown that such stresses are concentrated on the raised area 22 of the thermal strain relief device 18. As shown in FIG. 6, under initial tightening loads, the thermal strain relief device 18 is configured to deform in the areas shown, as applied to the raised area 22 and concentrated on the body 20.

By using the thermal strain relief device 18 of the subject invention is conjunction with an assembly including at least a connector 16 and first and second components 12, 14, stresses on the connector 16 can be reduced, as compared to an assembly without the thermal strain relief device 18. Stresses on the connector 16 can be evaluated by measuring the contact resistance between the first and second components 12, 14, in particular, by measuring the change in electrical resistance of the first component (heater) 12 before and after bake-out, i.e., heating of the first component to an operating temperature of between about 1000° C. and about 1700° C. in a furnace. An example is described below.

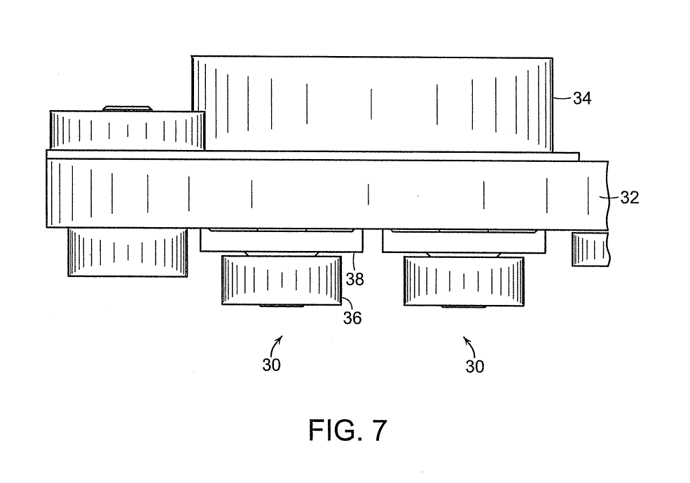

As shown in FIG. 7, according to the subject invention, one or more assemblies 30 incorporating the subject invention can be provided in a furnace, where two such assemblies are depicted in FIG. 7. For example, each assembly 30 can include at least a first component (or heater) 32 and a second component (or electrode) 34 that are connected by a connector 36, where each assembly includes a thermal strain relief device 38. These components correspond respectively to similarly named components as described herein.

A method for connecting a plurality of components in a furnace, according to the subject invention, preferably includes at least the following steps: providing at least first and second components in the furnace; providing a thermal strain relief device having a body, a raised area provided on a first side of the body, and an elevation structure provided on a second side of the body; connecting the at least first and second components in the furnace using a connector, where the connector and the first and second components are made of materials having different coefficients of thermal expansion; tightening the connector against the raised area of the thermal strain relief device, such that the raised area contacts the connector, and the elevation structure contacts at least one of the first and second components; and subjecting the thermal strain relief device, the connector, and the at least first and second components to a high temperature environment, the connector being configured to flex in response to different thermal expansion rates of the connector and the first and second components. Further, the high temperature environment includes operating temperatures of greater than about 1000° C., and more preferably about 1000° C. and about 1700° C. The thermal strain relief device is configured to flex in response to the tightening of the connector against the raised area of the thermal strain relief device, where the thermal strain relief device flexes so as to counteract thermal expansion of at least one of the connector, the first component, and the second component.

### Example

In the “hot zone” of a DSS furnace, which operates at high temperatures of between about 1000° C. and about 1700° C., a heater is attached to an electrode by a plurality of studs. In conventional assemblies, which do not include a spring clip, washer, or fastener similar to the thermal strain relief device 18 of the subject invention, the studs are subject to a high failure rate. The level of initial tightening stress of the stud against the heater and the electrode, and the variation in material properties (i.e., different coefficients of thermal expansion of the stud, heater, and/or electrode) leads to the high failure rate of the stud. However, when a thermal strain relief device 18 made of a graphite material such as SIGRABOND PREMIUM available from SGL Group is used, the thermal strain relief device 18 can deform under initial tightening loads, and additionally deform during operation in a high temperature environment to account for differences in thermal expansion rates of the stud, heater, and electrode.

In this example, each kit includes a plurality of assemblies each including a connector, heater, and electrode. In each table, a comparison is made between a respective assembly, as provided without and with a thermal strain relief device 18 according to the subject invention. In particular, the resistance of the heater is measured upon initial installation and after one run, and subsequently measured after four runs. The results are indicated in Tables 1 and 2 below, reflecting different kits.

TABLE 1
Resistance of heater in assembly kit A provided without a thermal strain relief
device (shaded area), and with a thermal strain relief device (unshaded).

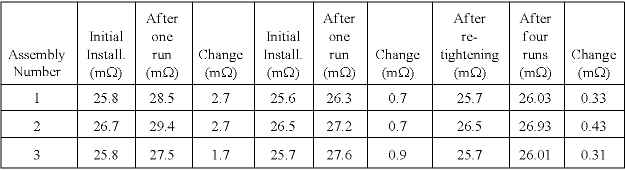

TABLE 2
Resistance of heater in assembly kit B provided without a thermal strain relief
device (shaded area), and with a thermal strain relief device (unshaded).

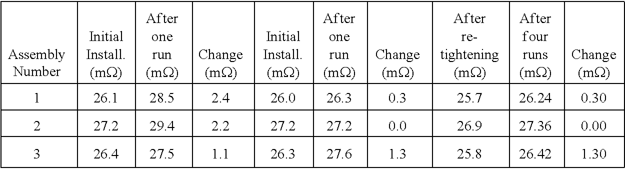

As indicated by the results provided above, use of a thermal strain relief device according to the subject invention reduces the electrical contact resistance in the heater after one run, as compared to an assembly without the thermal strain relief device. The change in contact resistance of the heater is reduced by a factor of about 4 to 7 times depending on the heater and the temperature. In other words, by including the thermal strain relief device in an assembly, the thermal strain relief device can reduce stress on the connector, as exhibited by the reduction in contact resistance of the heater, where this stress reduction is apparent after one run, and subsequently after four runs, thus confirming that the thermal strain relief device can absorb mismatches between the coefficients of thermal expansion of the various components, and the effect of thermal swings.

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications and other references cited herein are hereby expressly incorporated herein in their entireties by reference.

What is claimed is:

1. A system for connecting a plurality of components in a furnace, comprising:
at least first and second components provided in the furnace;
a connector for connecting the at least first and second components in the furnace, the connector and the first and second components being made of materials having different coefficients of thermal expansion; and
a thermal strain relief device arranged intermediate at least a portion of the connector and at least one of the first and second components, the thermal strain relief device abutting the connector and the at least one of the first and second components,
the thermal strain relief device having a body, a raised area provided on a first side of the body, the raised area contacting the connector, and an elevation structure provided on a second side of the body, the elevation structure contacting at least one of the first and second components.

2. The system of claim 1, wherein the thermal strain relief device is formed with at least a hole for receiving the connector.

3. The system of claim 1, wherein the elevation structure of the thermal strain relief device includes at least two legs so as to elevate the body above a plane defined by the at least one of the first and second components.

4. The system of claim 1, wherein the raised area of the thermal strain relief device has a surface area less than a surface area of the body of the thermal strain relief device.

5. The system of claim 4, wherein the raised area include at least one tapered edge formed on the body of the thermal strain relief device.

6. The system of claim 1, wherein the thermal strain relief device is made of graphite or a carbon-carbon composite.

7. The system of claim 1, wherein the thermal strain relief device is made of a carbon-based material having a tensile strength of at least about 45 MPa.

8. The system of claim 1, wherein the thermal strain relief device is configured to flex in response to tightening of the connector against the thermal strain relief device.

9. The system of claim 1, wherein the thermal strain relief device is configured to flex so as to counteract thermal expansion of at least one of the connector, the first component, and the second component.

10. The system of claim 1, wherein the furnace is operated at temperatures of greater than about 1000° C.

11. A thermal strain relief device configured to be assembled with a connector and at least first and second components in a furnace, comprising:
a body;
a raised area provided on a first side of the body, the raised area contacting the connector that connects at least first and second components, wherein the connector and the first and second components have different coefficients of thermal expansion; and
an elevation structure provided on a second side of the body, the elevation structure contacting at least one of the first and second components,
the thermal strain relief device being arranged intermediate to at least a portion of the connector and at least one of the first and second components.

12. The thermal strain relief device of claim 11, further comprising at least a hole for receiving the connector.

13. The thermal strain relief device of claim 11, wherein the elevation structure includes at least two legs so as to elevate the body above a plane defined by the at least one of the first and second components.

14. The thermal strain relief device of claim 11, wherein the raised area has a length that is shorter than a length of the body.

15. The thermal strain relief device of claim 14, wherein the raised area include at least one tapered edge formed on the body.

16. A method for connecting a plurality of components in a furnace, comprising:
providing at least first and second components in the furnace;
providing a thermal strain relief device having a body, a raised area provided on a first side of the body, and an elevation structure provided on a second side of the body;
connecting the at least first and second components in the furnace using a connector, wherein the connector and the first and second components are made of materials having different coefficients of thermal expansion;
tightening the connector against the raised area of the thermal strain relief device, such that the raised area contacts the connector, and the elevation structure contacts at least one of the first and second components; and
subjecting the thermal strain relief device, the connector, and the at least first and second components to a high temperature environment, the connector being configured to flex in response to thermal expansion of the connector and the first and second components.

17. The method of claim 16, wherein the high temperature environment includes operating temperatures of greater than about 1000° C.

18. The method of claim 16, wherein the high temperature environment includes operating temperatures of between about 1000° C. and about 1700° C.

19. The method of claim 16, wherein the thermal strain relief device is configured to flex in response to the tightening of the connector against the raised area of the thermal strain relief device.

20. The method of claim 16, wherein the thermal strain relief device flexes so as to counteract thermal expansion of at least one of the connector, the first component, and the second component.
